(19) United States
(12) Patent Application Publication
(10) Pub. No.: US 2004/0180803 A1
(43) Pub. Date: Sep. 16, 2004

(54) Laundry detergent compositions

(76) Inventors: Sarah Dixon, Bebington Wirral (GB); Peter Leslie Gratton, Bebington Wirral (GB); John Oakes, Winsford (GB)

Correspondence Address: UNILEVER, PATENT DEPARTMENT, 45 RIVER ROAD, EDGEWATER, NJ, 07020, US

(21) Appl. No.: 10/485,445

(22) PCT Filed: Jul. 30, 2002
(86) PCT No.: PCT/EP02/08535

(30) Foreign Application Priority Data
Aug. 2, 2001 (GB) 0118932.3

(51) Int. Cl. C11D 3/00

(52) U.S. Cl. 510/375

(57) ABSTRACT

A detergent composition which comprises: a surfactant, a builder, a fluorescer; one or more of a bleach precursor which is preferably N,N,N′N′-tetra-acetyl ethylene diamine or sodium nonanoyloxy benzene sulphonate, one or more of a hydrogen peroxide source which is preferably an alkali metal perborate or percarbonate. Optionally it comprises a nitrogen-containing dye binding polymer selected from polymers and co-polymers of vinyl-pyrrolidone, vinyl-pyridine N-oxide, and vinyl-imidazole, and mixtures thereof. The composition is essentially free of copper binding species, other than those which are deactivated by calcium salts.

### FIELD OF THE INVENTION

The present invention relates to improved laundry compositions and in particular to those which comprise a peroxygen-based bleaching system.

### BACKGROUND OF THE INVENTION

Bleaching agents are common components of laundry formulations currently available in the marketplace. Typically these include some source of hydrogen peroxide. In many commercial formulations, the hydrogen peroxide is derived from a peroxygen-source such as perborate or percarbonate.

Bleaches attack stains on articles being washed and also attack other coloured materials, such as dyestuffs, which are released into the wash liquor during the wash. It is known that the redeposition of these labile dyestuffs and coloured materials derived from stains can reduce the background whiteness of fabrics. In some cases a significant reduction in background whiteness may occur after a single wash. Thus, the bleaches do not only work on the primary soiling, but also have a secondary benefit in relation of so called ‘dye transfer’.

Metal catalysis of bleaching agents in laundry processes is well known. In general, this is perceived as deleterious and steps are taken to remove active metal ions from bleach-containing compositions. Otherwise, metals can decompose bleaching species in the aqueous phase, thereby rendering the product less effective. Such steps have included the addition of chelating agents for copper, iron and other metals.

Attempts have been made to use the catalytic properties of metals to advantage, by using them to boost the activity of bleaches. Many metals have been the subjects of research, with interest being particularly focused on Fe, Co and Mn.

U.S. Pat. No. 3,156,654; U.S. Pat. No. 3,532,634 and GB-A-984,459 disclose use of copper salts together with a chelating agent, to improve the efficacy of perborate, percarbonate and hydrogen peroxide bleaches.

It is believed that in these systems, the copper acts as a catalyst for the bleach. However, the chelating agent reduces the level of active copper in the liquid phase thereby preventing unwanted reactions in the wash liquor. The only copper which remains active is that which has been adsorbed onto the article being laundered and more particularly, onto stains.

Modern washing compositions use so-called bleach precursors to improve the performance of hydrogen peroxide. ‘TAED’ (tetra acetyl ethylene diamine) is a well known bleach precursor which is widely used in laundry formulations. ‘SNOBS’ (sodium nonanoyl oxy-benzene sulphonate) is another well-known and widely used bleach precursor.

In use, the precursor reacts with an excess of hydrogen peroxide to form a more reactive peracid bleach. Typical laundry formulations use an excess of peroxygen source with a precursor:peroxygen source mole ratio of at least 1:3 for SNOBS and 1:8 for TAED. TAED, in reacting with H202 forms the peracid bleach peracetic acid and SNOBS forms the peracid bleach pernonanoic acid.

In the case of TAED and other similar precursors, a further reaction between the excess of H₂O₂ and the peracid formed from the precursor (for example the peracetic acid) is believed to be particularly sensitive to the presence of trace metals. If these are present, the peracid is lost at a rate which far outweighs any benefits due to adsorption of the metal at the article surface. It is therefore commonplace in such systems to eliminate trace metals by the use of chelating agents.

GB-A-2150944 discloses a fabric washing detergent composition designed for washing mixed colours which comprises a peracid or precursor thereof, 0.002-2.5% copper in the absence or substantial absence of a sequestrant which complexes strongly with copper. That specification states (see page 7, line 28) that no positive catalysis of dye or stain bleaching, on the fabric, is observed from copper added to the wash solution.

A technical problem which the present patent addresses is concerned with how one should obtain the full benefits of metal catalysis in systems which contain bleach precursors and peroxygen sources, i.e. both reduction of dye transfer and cleaning benefits against stains.

A further technical problem which occurs due to dye transfer is the quenching of fluorescers by re-deposited dyes. Fluorescers, are typically added to detergent compositions to improve the ‘whiteness’ of the articles being washed. Even very small amounts of re-deposited dyes can ‘quench’ the fluorescence and cause a dramatic reduction in the apparent ‘whiteness’ of the fabric.

### BRIEF DESCRIPTION OF THE INVENTION

We have determined that, with compositions containing a bleach precursor, the presence of uncompleted copper brings about enhanced bleaching performance both on soiling and on labile dyestuffs and other coloured materials.

Accordingly, the present invention provides a method of laundering articles in a wash liquor which comprises the step of treating said articles with a detergent composition which composition comprises:

a) a surfactant,

b) a fluorescer,

c) a builder,

d) a bleach precursor which reacts with hydrogen peroxide to form a peracid, and;

e) a source of hydrogen peroxide, wherein:

1) the molar ratio of the hydrogen peroxide source to the bleach precursor is 1:<2N where N is the number of moles of peracid derived from a mole of the bleach precursor, and,

2) the only copper binding species, other than those which are deactivated by calcium salts, which are present are those for which the logK of any complex that has the potential to form between the copper binding species and copper is less than 10,

3) the composition is free of EDTA, and,

4) the method is performed in the presence of copper ions.

Preferably, the ratio of precursor to peroxygen source in the composition is 1:0.5N to 1:2N where N is the number of moles of peracid derived from a mole of precursor. For laundry formulations according to the present invention the precursor:peroxygen-source mole ratios will be 1:0.5 to 1:2 for SNOBS and 1:1 to 1:4 for TAED.

It is preferable that the level of copper in the wash liquor is at least 0.001 ppm. While it is also preferable that the level of copper in the wash liquor does not exceed 1 ppm this level may be exceeded in locations where the supply of water contains high levels of copper.

Beneficially, it is not necessary to add copper as such to the formulation, as sufficient copper may be present in the laundry liquor. This copper may come, for example, from piping through which the water has passed or from dyes and/or stains.

Alternatively, copper salts or complexes may be added to the composition. Suitable complexing agents include sodium tri-polyphosphate. These materials bind strongly to hardness ions and therefore cease to be copper binding species once the composition comes into contact with water containing significant levels of calcium and/or magnesium.

Preferred complexes are those where the difference in log K between calcium and copper complexes is less than 5.

It is preferable that the wash is performed at a temperature of 30 Celsius or less. Such washing conditions are commonplace in some regions, particularly in the Southern Hemisphere.

The compositions according to the invention further comprise one or more fluorescent ‘whitening’ agents.

It is believed that the compositions of the present invention are sufficiently effective at preventing soil/dye transfer, that they significantly reduce quenching of the fluorescer by said soils/dyes.

### DETAILED DESCRIPTION OF THE INVENTION

Throughout the description and claims generic groups are used, for example alkyl, alkoxy, aryl etc. Unless otherwise specified the following are preferred group restrictions that may be applied to generic groups found within compounds disclosed herein:

alkyl:—linear and branched C1-C8-alkyl, preferably C1-C6;

alkenyl:—C2-C8-alkenyl, preferably C3-C6;

cycloalkyl:—C3-C8-cycloalkyl, preferably C6-C8;

cycloalkenyl:—C4-12-cycloalkenyl (preferably C4-C8) having a single cyclic ring or multiple condensed rings and at least one point of internal unsaturation which can be optionally substituted with from 1 to 3 C1-C8-alkyl groups;

aryl:—selected from homoaromatic compounds having a molecular weight under 300, preferably selected from group consisting of: phenyl; biphenyl; naphthalenyl; anthracenyl; and phenanthrenyl;

alkynyl:—C2-C12-alkynyl; alkylaryl: C1-12-alkylaryl, wherein the aryl selected from homoaromatic compounds having a molecular weight under 300;

halogen:—selected from the group consisting of: F; Cl;

Br and I, preferably F and Cl; and,

alkoxy:—C1-C6-alkoxy, preferably C1-C4.

Peroxygen Source and Bleach Precursors:

As noted above the compositions of the invention comprise a source of hydrogen peroxide in combination with a peroxyacid/peracid bleach precursor.

Hydrogen peroxide sources are well known in the art. They include the inorganic peroxides, for example alkali metal peroxides, organic peroxides for example as urea peroxide, and inorganic persalts, such as the alkali metal perborates, percarbonates, perphosphates, persilicates and persulphates. Mixtures of two or more such compounds may also be suitable.

Compositions of the invention also comprise a bleach precursor which can react with hydrogen peroxide to form a peracid.

Typical levels of peroxygen sources in fully formulated composition will range from 0.05 to 55 wt. % with 0.25% to 40 wt. % being particularly preferred and 0.1% to 25 wt. % being most particularly preferred.

The most preferred peroxygen sources include percarbonates and perborates. These are both believed to form H202 in the presence of water.

We particularly prefer that the composition comprises an alkali metal percarbonate, preferably sodium percarbonate, as a source of hydrogen peroxide. Also preferred are sodium perborate tetrahydrate and, especially, sodium perborate monohydrate. Sodium perborate monohydrate is preferred because of its high active oxygen content. Sodium percarbonate may also be preferred for environmental reasons.

Another suitable hydrogen peroxide source is a combination of a C₁-C₄ alkanol oxidase and a C₁-C₄ alkanol, especially a combination of methanol oxidase (MOX) and ethanol. Such combinations are disclosed in WO-A-9507972, which is incorporated herein by reference.

Alkylhydroxy peroxides are another class of peroxide source. Examples of these materials include cumene hydroperoxide and t-butyl hydroperoxide.

In addition to the peroxygen source, compositions according to the invention also comprise a peroxyacid/peracid precursor.

Suitable organic peroxyacids have the general formula:

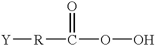

wherein R is an alkyl- or alkylidene- or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a —COOH or —COOOH group or a quaternary ammonium group.

Typical monoperoxy acids useful herein include, for example:

(i) peroxybenzoic acid and ring-substituted peroxybenzoic acids, e.g. peroxy-a-naphthoic acid;

(ii) aliphatic, substituted aliphatic and arylalkyl monoperoxyacids, e.g. peroxylauric acid, peroxystearic acid and N,N-phthaloylaminoperoxy caproic acid (PAP); and

(iii) 6-octylamino-6-oxo-peroxyhexanoic acid.

Typical diperoxyacids useful herein include, for example:

(i) 1,12-diperoxydodecanedioic acid (DPDA);

(ii) 1,9-diperoxyazelaic acid;

(iii) diperoxybrassylic acid; diperoxysebacic acid and diperoxyisophthalic acid;

(iv) 2-decyldiperoxybutane-1,4-dioic acid; and

(v) 4,4′-sulphonylbisperoxybenzoic acid.

Also inorganic peroxyacid compounds are suitable, such as for example potassium monopersulphate (MPS). If organic or inorganic peroxyacids are used, the amount thereof will normally be within the range of about 0.2-10% by weight, preferably from 0.4-8% by weight.

‘Bleach precursors’ suitable for use in the compositions of the present invention form a peracid in the presence of H202. These compounds are well-known and amply described in literature, such as in GB-A-836988; GB-A-864,798; GB-A-907,356; GB-A-1,003,310 and GB-A-1,519,351; DE-A-3,337,921; EP-A-0,185,522; EP-A-0,174,132; EP-A-0,120,591; and U.S. Pat. No. 1,246,339; U.S. Pat. No. 3,332,882; U.S. Pat. No. 4,128,494; U.S. Pat. No. 4,412,934 and U.S. Pat. No. 4,675,393.

Another useful class of bleach precursors is that of the cationic i.e. quaternary ammonium substituted precursors as disclosed in U.S. Pat. No. 4,751,015 and U.S. Pat. No. 4,397,757, in EP-A-0,284,292 and EP-A-331,229. Examples of bleach precursors of this class are:

2-(N,N,N-trimethyl ammonium)ethyl sodium-4-sulphophenyl carbonate chloride—(SPCC);

N-octyl,N,N-dimethyl-N₁₀-carbophenoxy decyl ammonium chloride—(ODC);

3-(N,N,N-trimethyl ammonium)propyl sodium-4-sulphophenyl carboxylate; and

N,N,N-trimethyl ammonium toluyloxy benzene sulphonate.

A further special class of bleach precursors is formed by the cationic nitriles as disclosed in EP-A-303,520; EP-A-458,396 and EP-A-464,880.

Of bleach precursors, the preferred classes are the esters, including acyl phenol sulphonates and acyl alkyl phenol sulphonates; the acyl-amides; and the quaternary ammonium substituted peroxyacid precursors including the cationic nitrites.

Examples of preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; 2-(N,N,N-trimethyl ammonium)ethyl sodium-4-sulphophenyl carbonate chloride (SPCC); trimethyl ammonium toluyloxy-benzene sulphonate; sodium nonanoyloxybenzene sulphonate (SNOBS); sodium 3,5,5-trimethyl hexanoyl-oxybenzene sulphonate (STHOBS); and the substituted cationic nitrites.

Of the peracid precursors, TAED and SNOBS preferred. As noted above these react with H₂O₂ to form the peracids peracetic and pernonanoic respectively which materials react with further H₂O₂ in the presence of uncomplexed copper to form active oxygen bleaching species.

The precursors are typically used in an amount of up to 12%, preferably from 0.2-10%, by weight of the composition.

Copper Binding Agents:

While the composition is free of materials that would bind copper so as to inactivate it during the wash, it is useful to have a copper binding agent present to prevent the copper being active in the composition during storage. Otherwise, the copper might bring about degradation of the bleaching system.

Advantageously, this binding agent should be deactivated (as regards copper) during the wash and this can be achieved by using a binding agent which binds more strongly to calcium (present in the wash liquor) than to copper.

As mentioned above, phosphate is a suitable binding agent and advantageously is already present in many formulations as a builder (in the form of sodium tripolyphosphate). Nitrilotriacetic Acid (NTA) is another binding agent which can complex with copper but which would be deactivated in the presence of significant levels of calcium.

Calcium is of course a commonplace water hardness ion and would be present in the wash liquor. Thus, when the compositions of the invention are being stored any copper ions present in the composition are effectively deactivated by the binding agent. On addition to water containing hardness ions, the binding agent releases the copper as it binds preferentially to the hardness ions (calcium). The copper is then free to catalyse the bleaching reaction.

DTI Polymers:

It is advantageous for the compositions of the invention to comprise one or more dye transfer inhibition (DTI) agents.

Any suitable dye-transfer inhibition agents may be used in accordance with the present invention, provided that this does not have a strong affinity for copper. Generally, such dye-transfer inhibiting agents include polyvinyl pyrrolidone polymers, polyamine N-oxide polymers, copolymers of N-vinylpyrrolidone and N-vinylimidazole, N-carboxymethyl-4-vinylpyridinium polymers, manganese pthalocyanine, peroxidases, and mixtures thereof.

The nitrogen-containing, dye binding, polymers are preferred.

Polyamine N-oxide polymers suitable for use herein contain units having the following structural formula: R-A_{X}-P; wherein P is a polymerizable unit to which an N—O group can be attached or the N—O group can form part of the polymerizable unit; A is one of the following structures: —NC(O)—, —C(O)O—, —S—, —O—, —N═; x is 0 or 1; and R is an aliphatic, ethoxylated aliphatic, aromatic, heterocyclic or alicyclic group or combination thereof to which the nitrogen of the N—O group can be attached or the N—O group is part of these groups, or the N—O group can be attached to both units.

Preferred polyamine N-oxides are those wherein R is a heterocyclic group such as pyridine, pyrrole, imidazole, pyrrolidine, piperidine and derivatives thereof. The N—O group can be represented by the following general structures: N(O) (R′)₀₋₃, or ═N(O) (R′)₀₋₁, wherein each R′ independently represents an aliphatic, aromatic, heterocyclic or alicylic group or combination thereof. The nitrogen of the N—O group can be attached or form part of any of the aforementioned groups. The amine oxide unit of the polyamine N-oxides has a pKa<10, preferably pKa<7, more preferably pKa<6.

Any polymer backbone can be used provided the amine oxide polymer formed is water-soluble and has dye transfer inhibiting properties. Examples of suitable polymeric backbones are polyvinyls, polyalkylenes, polyesters, polyethers, polyamides, polyimides, polyacrylates and mixtures thereof. These polymers include random or block copolymers where one monomer type is an amine N-oxide and the other monomer type is an N-oxide. The amine N-oxide polymers typically have a ratio of amine to the amine N-oxide of 10:1 to 1:1,000,000. However, the number of amine oxide groups present in the polyamine oxide polymer can be varied by appropriate copolymerization or by an appropriate degree of N-oxidation. The polyamine oxides can be obtained in almost any degree of polymerization. Typically, the average molecular weight is within the range of 500 to 1,000,000; more preferably 1,000 to 500,000; most preferably 5,000 to 100,000. This preferred class of materials is referred to herein as “PVPy-NO”. A preferred polyamine N-oxide is poly(4-vinylpyridine-N-oxide) which as an average molecular weight of about 50,000 and an amine to amine N-oxide ratio of about 1:4.

Block or random copolymers of N-vinylpyrrolidone and N-vinylimidazole polymers (as a class, referred to as “PVP/PVI”) are also preferred. Preferably the PVP/PVI has an average molecular weight range from 5,000 to 1,000,000, more preferably from 5,000 to 200,000, and most preferably from 10,000 to 20,000, as determined by light scattering as described in Barth, et al., Chemical Analysis, Vol. 113. “Modern Methods of Polymer Characterization”).

The preferred PVP/PVI copolymers typically have a molar ratio of N-vinylimidazole to N-vinylpyrrolidone from 1:1 to 0.2:1, more preferably from 0.8:1 to 0.3:1, most preferably from 0.6:1 to 0.4:1. These copolymers can be either linear or branched. Suitable PVP/PVI polymers include Sokalan™ HP56, available commercially from BASF, Ludwigshafen, Germany.

Also preferred as dye transfer inhibition agents are polyvinylpyrrolidone polymers (“PVP”) having an average molecular weight of from about 5,000 to about 400,000, preferably from about 5,000 to about 200,000, and more preferably from about 5,000 to about 50,000. PVP's are disclosed for example in EP-A-262,897 and EP-A-256,696.

Suitable PVP polymers include Sokalan™ HP50, available commercially from BASF. Compositions containing PVP can also contain polyethylene glycol (“PEG”) having an average molecular weight from about 500 to about 100,000, preferably from about 1,000 to about 10,000. Preferably, the ratio of PEG to PVP on a ppm basis delivered in wash solutions is from about 2:1 to about 50:1, and more preferably from about 3:1 to about 10:1.

Also suitable as dye transfer inhibiting agents are those from the class of modified polyethyleneimine polymers, as disclosed for example in WO-A-0005334. These modified polyethyleneimine polymers are water-soluble or dispersible, modified polyamines. Modified polyamines are further disclosed in U.S. Pat. No. 4,548,744; U.S. Pat. No. 4,597,898; U.S. Pat. No. 4,877,896; U.S. Pat. No. 4,891, 160; U.S. Pat. No. 4,976,879; U.S. Pat. No. 5,415,807; GB-A-1,537,288; GB-A-1,498,520; DE-A-28 29022; and JP-A-06313271.

Preferably the composition according to the present invention comprises a dye transfer inhibition agent selected from polyvinylpyrridine N-oxide (PVPy-NO), polyvinyl pyrrolidone (PVP), polyvinyl imidazole, N-carboxymethyl-4-vinylpyridinium, N-vinylpyrrolidone and N-vinylimidazole copolymers (PVP/PVI), copolymers thereof, and mixtures thereof.

The amount of dye transfer inhibition agent in the composition according to the present invention will be from 0.01 to 10%, preferably from 0.02 to 5%, more preferably from 0.03 to 2%, by weight of the composition.

Surfactants and Builders:

The composition contains a surface-active material in an amount, for example, from 5 to 50% by weight.

Certain surface active agents should preferably be avoided in compositions of the invention. These are the ones that can complex with copper. Soap is one such surfactant, but it is believed that its effects may be mitigated in a well-built system.

The surface-active material may comprise a synthetic material selected from anionic, nonionic, amphoteric, zwitterionic, cationic actives and mixtures thereof. Many suitable actives are commercially available and are fully described in the literature, for example in “Surface Active Agents and Detergents”, Volumes I and II, by Schwartz, Perry and Berch.

Typical synthetic anionic surface-actives are usually water-soluble alkali metal salts of organic sulphates and sulphonates having alkyl groups containing from about 8 to about 22 carbon atoms, the term “alkyl” being used to include the alkyl portion of higher aryl groups.

Examples of suitable synthetic anionic detergent compounds are sodium and ammonium alkyl sulphates, especially those obtained by sulphating higher (C₈-C₁₈) alcohols produced, for example, from tallow or coconut oil; sodium and ammonium alkyl (C₉-C₂₀) benzene sulphonates, particularly sodium linear secondary alkyl (C₁₀-C₁₅) benzene sulphonates; sodium alkyl glyceryl ether sulphates, especially those ethers of the higher alcohols derived from tallow or coconut oil fatty acid monoglyceride sulphates and sulphonates; sodium and ammonium salts of sulphuric acid esters of higher (C₉-C₁₈) fatty alcohol alkylene oxide, particularly ethylene oxide, reaction products; the reaction products of fatty acids such as coconut fatty acids esterified with isethionic acid and neutralised with sodium hydroxide; sodium and ammonium salts of fatty acid amides of methyl taurine; alkane monosulphonates such as those derived by reacting alpha-olefins (C₈-C₂₀) with sodium bisulphite and those derived by reacting paraffins with SO₂ and Cl₂ and then hydrolysing with a base to produce a random sulphonate; sodium and ammonium (C₇-C₁₂) dialkyl sulphosuccinates; and olefin sulphonates, which term is used to describe material made by reacting olefins, particularly (C₁₀-C₂₀) alpha-olefins, with S0₃ and then neutralising and hydrolysing the reaction product. The preferred anionic detergent compounds are sodium (C₁₀-C₁₅) alkylbenzene sulphonates (C₁₀-C₁₅ LAS), and sodium (C₁₆-C₁₈) alkyl ether sulphates (C16-C18 LES).

Examples of suitable nonionic surface-active compounds which may be used, preferably together with the anionic surface-active compounds, include, in particular, the reaction products of alkylene oxides, usually ethylene oxide, with alkyl (C₆-C₂₂) phenols, generally 5-25 EO, i.e. 5-25 units of ethylene oxides per molecule; and the condensation products of aliphatic (C₈-C₁₈) primary or secondary linear or branched alcohols with ethylene oxide, generally 2-30 EO. Other so-called nonionic surface-actives include alkyl polyglycosides, sugar esters, long-chain tertiary amine oxides, long-chain tertiary phosphine oxides and dialkyl sulphoxides.

Amphoteric or zwitterionic surface-active compounds can also be used in the compositions of the invention but this is not normally desired owing to their relatively high cost. If any amphoteric or zwitterionic detergent compounds are used, it is generally in small amounts in compositions based on the much more commonly used synthetic anionic and nonionic actives.

The composition will preferably comprise from 1 to 30% wt of anionic surfactant and from 0 to 40 % wt of nonionic surfactant. Preferred classes of formulations comprise 10-30% wt of anionic surfactant, particularly around 6% wt, and up to 1% wt of nonionic surfactant.

Another preferred embodiments of the present invention comprise a mixed active system which comprises significant amounts of both anionic and nonionic surfactants. Where nitrogen-containing, dye binding, DTI polymers are used, the effectiveness of these polymers is reduced at high levels of anionic surfactant.

It is preferable that the level of anionic surfactant (on total surfactant) ranges from 10-90% wt and that the level of nonionic ranges from 90-10% wt (on total surfactant). It is especially preferred, when DTI polymers are present, to use 30-60% wt/surfactant of anionic surfactant selected from: LAS, PAS, and mixtures thereof, together with 70-40% wt/surfactant of ethoxylated alcohol nonionic surfactant.

The composition may also contain a detergency builder, for example in an amount of from about 5 to 80% by weight, preferably from about 10 to 60% by weight.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070.

In particular, the composition may contain any one of the organic and inorganic builder materials, though, for environmental reasons, phosphate builders are preferably omitted or only used in very small amounts.

Apart from the components already mentioned, the composition can contain any of the conventional additives in amounts of which such materials are normally employed in fabric washing detergent compositions. These include, perfumes; enzymes, such as proteases, cellulases, lipases, amylases and oxidases; germicides and colourants. However, care should again be taken not to include materials which have a significant copper complexing ability. As will be seen from the examples below, certain anti-redeposition agents such as CP5 need to be excluded from formulations.

The present invention may be conveniently embodied in a solid form of product, which includes both a powder or tablet form of product. Both of these forms may be homogeneous or non-homogeneous. For example tablets may comprise a plurality of discrete regions which include some ingredients only, While powders may comprise mixed granules of differing compositions.

In order that the present invention may be further and better understood it is described below with reference to non-limiting examples.

### EXAMPLES

All fabrics were measured after washing on a Datacolour™ SF600 Plus Spectraflash™ which was calibrated using the following settings:

UV Excluded—420 nm cutoff

Specular Included

Large (30 mm) aperture

Each monitor was measured through one thickness of cloth with the white tile as the reference standard. Each monitor was measured four times and the average of these four measurements was taken to be the value of that monitor.

LabCH values were taken and converted into delta E values by calculating the difference in L, a and b between the after wash measurements and those of an identical white cloth which had not been washed and then applying the equation:

ΔE=\sqrt{(ΔL²+Δa²+Δb²)}

The average delta E was calculated from series of results. 1.48 g/L Zeolite MAP, 0.5 g/L sodium carbonate) with the additions shown (in g/L). ‘Bleach’ is sodium percarbonate. 0.2 mls of a 1 g/L solution of dye was added with one 13 cm×13 cm piece of ECE desized mercerised non-fluorescent cotton sheeting. This was rinsed in demineralised water and tumble dried.

Copper, as required, was added as copper sulphate pentahydrate (1 ppm=3.93 mg/L).

Table 2 shows the results of the dye transfer experiments (as delta E) using the dyes listed and compositions A-E.

TABLE 1

| | | | | Dequest | |
|---|---|---|---|---|---|
| | TAED | Bleach | PVP | 2047 | Copper |
| A (control) | — | — | — | — | — |
| B (comparative) | 0.275 | 0.95 | — | 0.05 | — |
| C (comparative) | 0.413 | 0.57 | 0.035 | — | — |
| D (copper) | 0.413 | 0.57 | — | — | 1 ppm |
| E (copper and PVP) | 0.413 | 0.57 | 0.035 | — | 1 ppm |

TABLE 2

| | A | B | C | D | E |
|---|---|---|---|---|---|
| Dyestuff | Control 1 | Control 2 | PVP | Cu | PvP/Cu |
| D Black 022 | 10.57 | 10.4 | 4.31 | 1.18 | 1.23 |
| D Blue 071 | 19.89 | 18.32 | 3.51 | 4.06 | 1.92 |
| D Blue 218 | 5.03 | 5.21 | 3.87 | 1.47 | 1.53 |
| D Green 26 | 11.83 | 12.74 | 1.66 | 1.43 | 0.79 |
| D Red 075 | 15.17 | 16.3 | 4.04 | 1.22 | 1.15 |
| D Red 080 | 16.85 | 17.72 | 9.61 | 8.75 | 7.2 |
| D Red 089 | 16.09 | 15.34 | 8.03 | 1.57 | 2.54 |
| D Red 111 | 13.36 | 12.56 | 5.89 | 11.81 | 3.44 |
| D Red 224 | 13.4 | 13.53 | 8.54 | 3.43 | 5.52 |
| D Violet 47 | 16.62 | 19.42 | 7.43 | 1.56 | 1.44 |
| D Yellow 050 | 16.56 | 17.32 | 3.83 | 13.2 | 3.06 |
| D Yellow 086 | 13.58 | 13.14 | 3.95 | 13.42 | 3.07 |
| Average | 14.08 | 14.33 | 5.39 | 5.26 | 2.74 |

From Table 2 it can be seen that copper shows excellent activity against most of the dyes. While PVP and copper all show some activity against most dyes, the combination of the two shows excellent activity against all of the dyes.

### Example 2

### Copper in STP Formulations

Table 3 shows the formulations of shaker-bath dye-transfer experiments (100 Hz, 40° C., 30 mins) in 100 mls of a washing solution (0.5 g/L LAS (Petrelab 550), 0.35 g/L Nonionic (Synperonic A7), 0.87 g/L STP, 0.522 g/L sodium carbonate) with the additions shown (in g/L). The formulations also contained 0.154 g/L TAED, 1.4 g/L Na perborate tetrahydrate. 0.2 mls of a 1 g/L solution of dyes as listed was added with 113 cm×13cm piece of ECE desized mercerised non-fluorescent cotton sheeting. This was rinsed in demineralised water and tumble dried. Copper was added as copper sulphate penta-hydrate (1 ppm=3.93 mg/L).

Table 4 shows the results of the dye transfer experiments (as delta E) using the dyes listed and compositions A, B and D.

TABLE 3

| | PVP | Copper |
|---|---|---|
| A (control) | — | — |
| B (comparative) | 0.035 | — |
| D (copper) | — | 1 ppm |

TABLE 4

| | A | B | D |
|---|---|---|---|
| | Control | PVP | Copper |
| D Black 022 | 9.92 | 3.87 | 2.06 |
| D Blue 071 | 20.16 | 2.57 | 16.18 |
| D Blue 218 | 4.80 | 3.18 | 2.09 |
| D Green 26 | 12.85 | 1.47 | 10.23 |
| D Red 075 | 15.43 | 3.2 | 4.52 |
| D Red 080 | 17.40 | 7.47 | 16.92 |
| D Red 089 | 15.30 | 6.93 | 10.17 |
| D Red 111 | 13.68 | 4.47 | 14.55 |
| D Red 224 | 12.46 | 7.21 | 12.07 |
| D Violet 47 | 17.15 | 5.53 | 8.92 |
| D Yellow 050 | 15.60 | 1.89 | 14.62 |
| D Yellow 086 | 12.59 | 1.84 | 13.06 |
| Average | 13.94 | 4.14 | 10.45 |

Washing experiments were performed in Brazilian washing machines, with a 40 minute soak, and a 14 minute wash in 25° C. water of 6 degrees French hardness. This was followed by 1 rinse and tumble drying. Washes were done with 45 litre wash 5 volume, 1.8 g/L product, and 1.5 kg of load. The fabric used was 1200 g non-mercerised white cotton sheeting as ballast and one knitted white cotton t-shirt which had been stained. Two sets of stain monitors were pinned to mercerised cotton backing pieces. Stain removal and pickup on both the ballast and the backing pieces was measured. The values quoted are relative to a white tile standard. UV was excluded in the measurements.

Results are shown in Table 1. In the case where TAED/perborate (comparative) was added, a 1:7.5 ratio of TAED:perborate was used; for TAED/perborate plus copper (embodiment), a 1:3 ratio was used together with 1 ppm copper sulphate.

From the results it can be seen that the use of copper significantly reduces the background greying which occurs when an article is washed in the product. This reduction is not achieved with TAED/Perborate alone. It can also be seen that while TAED/perborate has an effect on some stains it is by no means effective on all of them. In some cases (marked ‘*’) after addition of TAED/perborate the results are worse than if no bleach had been added. The addition of copper corrects this deficiency.

When viewed in natural light, the whites washed in copper look brilliantly white in comparison to OMO MA (ex. Gessy Lever, Brazil) and OMO MA/TAED/Perborate. It is believed that this is because the fluorescer is not quenched by re-deposited stain.

TABLE 1

| | | OMO MA | | OMO MA |
|---|---|---|---|---|
| | | ex. | OMO MA | plus |
| Stain/Other | | Gessy | plus TAED/ | TAED/Cu |
| test | Unwashed | Lever | Perborate | Perborate |
| Ballast cotton | 3.5 | 6.1 | 5.5 | 3.4 |
| Backing piece | 4.1 | 8.8 | 8.1 | 3.7 |
| Ink | 72.3 | 30.5 | 31.2* | 28.9 |
| Tomato Puree | 38.4 | 11.1 | 12.0* | 7.6 |
| Mustard | 60.4 | 32.7 | 32.3 | 31.1 |
| Dende Oil | 83.1 | 23.3 | 23.0 | 19.6 |
| Gravy | 27.9 | 10.8 | 11.0* | 9.5 |
| Chilli Oil | 50.5 | 11.8 | 12.3* | 8.0 |
| Green Curry | 40.8 | 24.2 | 24.3* | 24.1 |
| Red Curry | 55.4 | 44.1 | 42.0 | 39.1 |

Washes were done with 41 litres wash volume, 1.8 g/L product, and 1.5 kg of load. The fabric used was 750 g fluorescent non-mercerised white cotton sheeting and 750 g non-fluorescent mercerised white cotton sheeting as ballast (of which six pieces were used as pick-up monitors). One or two sets of stain monitors were added in with the load. Pickup on the ballast was measured. The values quoted are relative to a white tile standard. UV was included in the measurements. Three replicate loads were washed per condition. One wash was performed per load. Stains used were 2× annato/oil, tumeric/oil, mustard, curry paste, elefante tomato paste, blue Parker Quink permanent for high stain conditions and 1× each for low stain conditions. Ganz whiteness results were obtained (7:1 molar ratio Perborate/TAED). Higher Ganz values are indicative of whiter cloth. Results are given in Table 6 below.

TABLE 6

| | | Brilhante | Brilhante | Brilhante |
|---|---|---|---|---|
| | Ace | (ex. Gessy Lever) | 0.1 ppm | 1.0 ppm |
| | (ex P&G) | 0 ppm added Cu | added Cu | added Cu |
| High | 119 | 147 | 168 | 173 |
| stain | | | | |
| Low | 152 | 164 | 178 | 176 |
| stain | | | | |

### Example 5

### Anti-Redeposition in Tergometer™

One wash was performed for each condition at 1 wash per load. Washes used 20 g fabric, 1 litre of water, 1.8 g/L product (Brilhante/Ace). The Tergometer™ was operated at 90 rpm, using a 30 min soak, 15 min wash, 2×2 min rinse and then the product was tumble dried. Mercerised non-fluorescent cotton was used as pickup monitor (4 pieces per condition). High stain conditions used 2× annato/oil (1 mL on 10×10 cm cotton). Low stain conditions used 1× annato/oil. Ganz whiteness results were obtained. In this example there was a 7:1 molar ratio Perborate/TAED. Results are given in Table 7.

TABLE 7

| | | Brilhante | Brilhante | Brilhante |
|---|---|---|---|---|
| | Ace | 0 ppm Cu | 0.1 ppm Cu | 1.0 ppm Cu |
| High stain | 107 | 116 | 142 | 152 |
| Low stain | | 158 | | 174 |

### Example 6

### Anti-Redeposition in Linetester™

One wash was performed for each condition at 1 wash per load. Washes used 8.5 g fabric, 0.212 litre of water, 1.8 g/L product (Brilhante/Ace). The Tergometer™ was operated at 90 rpm, using a 30 min soak, 15 min wash, 2×2 min rinse and then the product was tumble dried. Mercerised non-fluorescent cotton was used as pickup monitor (4 pieces per condition). Stain conditions used 1× annato/oil (0.5 mL on 10×10 cm cotton). Low stain conditions used 1× annato/oil. Ganz whiteness results were obtained. Results are given in Table 8.

TABLE 8

| | 4 g/L, | 2 g/L, | 2 g/L, | |
|---|---|---|---|---|
| | 10° FH., | 10° FH., | 2° FH., | 4 g/L, 2° FH., |
| | natural | no natural | natural | no natural |
| | soil, 40° C. | soil, 25° C. | soil, 40° C. | soil, 25° C. |
| Brilhante | 82 | 60 | 59 | 81 |
| 7:1 | | | | |
| 0 ppm Cu | | | | |
| Brilhante | 102 | 68 | 84 | 93 |
| 7:1 | | | | |
| 0.05 ppm Cu | | | | |
| Brilhante | 92 | 85 | 103 | 99 |
| 7:1 | | | | |
| 0.1 ppm Cu | | | | |
| Brilhante | 75 | 57 | 57 | 77 |
| 3:1 | | | | |
| 0 ppm Cu | | | | |
| Brilhante | 99 | 71 | 103 | 122 |
| 3:1 | | | | |
| 0.05 ppm Cu | | | | |
| Brilhante | 131 | 72 | 103 | 132 |
| 3:1 | | | | |
| 0.1 ppm Cu | | | | |

### Example 7

### Anti-Redeposition in Tergometer

One wash was performed for each condition at 1 wash per load. Washes used 20 g fabric, 1 litre of water, 1.8 g/L product (Brilhante). The Tergometer™ was operated at 90 rpm, using a 30 min soak, 15 min wash, 2×2 min rinse and then the product was tumble dried. Mercerised non-fluorescent cotton was used as pickup monitor (4 pieces per condition).

Stain conditions used 1× annato/oil (1 mL on 10×10 cm cotton). Results are given in Tables 9a and 9b.

TABLE 9a
(no copper present)

| | 0% | 0.25% | 0.5% | 0.75% |
|---|---|---|---|---|
| | TAED | TAED | TAED | TAED |
| 0% Perborate MH | 98 | 93 | 102 | 84 |
| 0.75% Perborate MH | 102 | 99 | 99 | 110 |
| 1.5% Perborate MH | 94 | 102 | 93 | 102 |

TABLE 9b
(0.1 ppm Cu)

| | 0% | 0.25% | 0.5% | 0.75% |
|---|---|---|---|---|
| | TAED | TAED | TAED | TAED |
| 0% Perborate MH | 95 | 90 | 109 | 100 |
| 0.75% Perborate MH | 107 | 128 | 129 | 125 |
| 1.5% Perborate MH | 109 | 119 | 125 | 132 |

In examples 4-7 fabrics were measured after washing Hunterlab™ XE relfectometer™ which was calibrated using the following settings: specular excluded, UV included and calibrated, large area view.

Each monitor was measured through four thicknesses of cloth with the white tile as the reference standard. Each monitor was measured once.

1. A method of laundering articles in a wash liquor which comprises the step of treating said articles with a detergent composition which composition comprises:
a) a surfactant,
b) a fluorescer,
c) a builder,
d) a bleach precursor which reacts with hydrogen is peroxide to form a peracid, and;
e) a source of hydrogen peroxide,
wherein:
1) the molar ratio of the hydrogen peroxide source to the bleach precursor is 1:<2N where N is the number of moles of peracid derived from a mole of the bleach precursor, and,
2) the only copper binding species, other than those which are deactivated by calcium salts, which are present are those for which the logK of any complex that has the potential to form between the copper binding species and copper is less than 10,
3) the composition is free of EDTA, and,
4) the method is performed in the presence of copper ions.

2. Method according to claim 1 wherein the level of copper in the wash liquor is at least 0.4 ppm.

3. Method according to claim 1 wherein the hardness of the water used for washing is 4-12 degrees French hardness.

4. Method according to claim 1 performed at a temperature of 40 degrees Celsius or less.

5. Method according to claim 1 wherein the hydrogen peroxide source is an alkali metal percarbonate or perborate.

6. Method according to claim 1 wherein the bleach precursor is selected from the group comprising;
sodium-4-benzoyloxy benzene sulphonate; N,N,N′N′-tetraacetyl ethylene diamine; sodium-1-methyl-2-benzoyloxy benzene-4-sulphonate; sodium-4-methyl-3-benzoloxy benzoate; 2-(N,N,N-trimethyl ammonium)ethyl sodium-4-sulphophenyl carbonate chloride; trimethyl ammonium toluyloxy-benzene sulphonate; sodium nonanoyloxybenzene sulphonate; sodium 3,5,5-trimethyl hexanoyl-oxybenzene sulphonate; the substituted cationic nitrites, and mixtures thereof.

7. A method according to claim 1 wherein the wash-liquor comprises a nitrogen-containing, dye binding, polymer.

8. A method according to claim 7, wherein the nitrogen containing dye binding polymer is selected from polymers and co-polymers of vinyl-pyrrolidone, vinyl-pyridine N-oxides and vinyl-imidazole, and mixtures thereof.

9. A method according to any of the previous claims wherein the wash-liquor is free from soap.
